(19) United States
(12) Patent Application Publication
(10) Pub. No.: US 2025/0347227 A1
(43) Pub. Date: Nov. 13, 2025

(54) BLADE ARRANGEMENT OF A THERMAL TURBOMACHINE THROUGH WHICH AXIAL FLOW MAY PASS, AND THERMAL TURBOMACHINE THROUGH WHICH AXIAL FLOW MAY PASS

(71) Applicant: MTU Aero Engines AG, Muenchen (DE)

(72) Inventor: Dennis VON BRAUNECK, Kottgeisering (DE)

(21) Appl. No.: 19/230,614

(22) Filed: Jun. 6, 2025

(30) Foreign Application Priority Data
Jun. 10, 2024 (DE) 102024116172.8

(51) Int. Cl. F01D 9/04; F01D 5/10

(52) U.S. Cl. CPC F01D 9/042; F01D 5/10; F05D 2230/31; F05D 2240/12; F05D 2260/96

(57) ABSTRACT

A blade arrangement for a thermal turbomachine through which axial flow may pass, including a guide blade ring having at least two guide blade elements situated along a circumferential direction of the turbomachine. Each guide blade element of the at least two guide blade elements includes at least one airfoil, which at its radially outer end includes a platform that is connected in one piece to the at least one airfoil. At least one hook section at its radially outer side protrudes from the platform in the radial direction. The at least one hook section in the radial direction forms a pocket of the guide blade element that is delimited by the at least one hook section, the guide blade element, and the platform, and that is open at one side in the axial direction of the turbomachine. The blade arrangement further includes at least one damping element that is situated in the pocket and connects at least two neighboring guide blade elements in the circumferential direction.

This claims priority to German Patent Application DE 102024116172.8 filed on Jun. 10, 2024 which is hereby incorporated by reference herein,

The present invention relates to a blade arrangement for a thermal turbomachine through which axial flow may pass.

### BACKGROUND

Turbomachines, in particular thermal turbomachines, gas turbines, or aircraft gas turbines, include guide blades as well as rotor blades. The guide blades are arranged on guide blade rings, while the rotor blades are arranged on rotor blade rings. Turbomachines often have several of these guide blade rings as stages, situated one behind the other, that are situated along a direction of a shaft of the particular turbomachine (axial direction). The task of the rotor blades is to provide the power for passing a gas through the turbomachine. For this purpose, the rotor blades are situated on a rotor of the turbomachine, and rotate along a circumferential direction during operation. In contrast, the guide blades are situated on a stator and are stationary during operation. The task of the guide blades is to appropriately guide the stream flowing through the turbomachine, so that the stream is supplied to the rotor blades at a predetermined angle. The guide blades are usually designed as single blades; this design has the advantage that good damping behavior is achieved.

### SUMMARY OF THE INVENTION

However, it may be advantageous to manufacture the guide blades as guide blade elements, each including multiple airfoils. Theoretically, these segments with multiple airfoils have reduced inherent damping compared to a design made up of single blades. The lower damping may result in stronger resonances and higher amplitudes of natural oscillations, which in turn may result in material stresses, or poorer fatigue strength or operational stability, which is disadvantageous.

It is an object of the present invention to provide a blade arrangement having improved resonance behavior, improved natural oscillation damping behavior, and also ease of manufacture of the guide blade elements.

The present invention provides a blade arrangement of a thermal turbomachine through which axial flow may pass. It also provides a turbomachine through which axial flow may pass. Advantageous embodiments with practical refinements are also set forth; advantageous embodiments of each aspect of the present invention are to be regarded as advantageous embodiments of the respective other aspects, and vice versa.

The present invention is based on the concept of providing a damping element that connects multiple guide blade elements to one another in the circumferential direction, and that provides damping or friction of the damping element at the guide blade elements in order to dissipate oscillation energy of a natural oscillation. This may result in improved fatigue strength behavior.

According to one embodiment of the present invention, a blade arrangement for a thermal turbomachine through which axial flow may pass is provided which includes a guide blade ring having at least two guide blade elements situated along a circumferential direction of the turbomachine, and at least one damping element. Each guide blade element of the at least two guide blade elements includes at least one airfoil, which at its radially outer end includes a platform that is connected in one piece to the at least one airfoil, at least one hook section at its radially outer side protruding from the platform in the radial direction, the hook section in the radial direction forming a pocket of the guide blade element that is delimited by the hook section, the guide blade element, and the platform, and that is open at one side in the axial direction of the turbomachine. The at least one damping element is situated in the pocket. In one preferred embodiment, the damping element may be dimensioned and arranged in such a way that it connects at least two neighboring guide blade elements in the circumferential direction, i.e., bridges the gap or circumferential-side joint between the guide blade elements.

In other words, the blade arrangement includes at least two guide blade elements that are arranged in the circumferential direction of the turbomachine. An axial/radial direction in each case refers to an axial/radial direction of the turbomachine. Each guide blade element includes at least one airfoil, at the radially outer end of which a platform is situated that preferably connects two, three, or more airfoils. The platform is preferably designed in one piece with the airfoils.

The hook section(s) is/are situated on the radially outer side of the platform. Two hook sections are preferably provided, one hook section forming a pocket that is open in the upstream direction, and one hook section forming a pocket that is open in the downstream direction. The pocket(s) is/are thus laterally situated, with respect to the radial direction, in an imaginary section plane that is perpendicular to the circumferential direction. In this case, the T-shaped arrangement of the hook sections provides sufficient space to introduce the pockets which accommodate damping elements. The pockets preferably have a continuous design in the circumferential direction, so that a damping element that extends along the circumferential direction may be inserted into the pocket.

Due to the one-piece design, the guide blade element may have an overall softer construction than in the case of a construction without the undercuts or hook sections, and integration of the damping elements is made possible, and in addition generates sufficient usable movement in the shroud. This means that movability is provided, and movements of the guide blade element may in turn be dissipated via friction of the damping element at the guide blade element. The damping elements may be designed and installed across segments, partially or as a ring or an overlapping C profile.

The present invention thus has the advantage that due to friction between the damping element and the guide blade element, damping of oscillations or movements is provided, and also that cost-effective, simple manufacturing is made possible due to the design of the guide blade element with multiple airfoils.

The present invention includes further advantageous embodiments that are described in greater detail below.

According to a further advantageous embodiment, it is provided that the pocket of each guide blade element of the at least two guide blade elements forms an undercut of the guide blade element in the radial direction. In other words, an undercut, i.e., formation of a pocket, of the guide blade element in the radial direction allows form-fit holding of the guide blade element in the housing, and in addition the undercut forms the pocket into which the damping element may be inserted. The undercut may be designed in such a way that it holds the damping element in a form-fit manner, or the undercut may be designed in such a way that the damping element is held in the pocket via the housing. This design has the advantage that the damping element may be held in a particularly satisfactory manner.

According to a further advantageous embodiment, it is provided that each guide blade element of the at least two guide blade elements is produced using an additive manufacturing process. In other words, the guide blade element may be produced by an additive or generative manufacturing process that builds up a component of a turbomachine in layers, for example. For example, a so-called “laser-based powder bed fusion of metals” (PBF-LB/M) process may be used. In this process, a complex component geometry is achieved by layer-by-layer melting and/or sintering of powder layers, for example a metal powder. However, in principle it is also possible to produce the blade arrangement using other manufacturing processes. When a manufacturing process such as casting and machining of guide blade elements, for example, is used, it is often difficult to form hook sections that are sufficiently large, and they can have only a small design. Thus, there may not be enough space available to form a pocket, and it is difficult or impossible to form the blade arrangement. In contrast, by use of the additive manufacturing process it is easier, for example, to form the hook sections to be larger than in a conventional case, and the hook sections may be more easily separated from the shroud.

According to a further advantageous embodiment, it is provided that the at least one damping element is designed as a corrugated metal sheet having an undulating structure in the circumferential direction. In other words, the damping element may be designed as a sheet metal spring, the sheet metal having an elastically resilient effect and being elastically deformed upon insertion into the pocket. The damping element acquires a damping property due to friction of the sheet metal spring at the points of contact with the guide blade element.

According to a further advantageous embodiment, it is provided that the at least one damping element has a wire-shaped design with a periodic shape in the circumferential direction. In other words, instead of the sheet metal the damping element may have a wire-shaped design with a periodic shape in the circumferential direction. For example, the damping element may have a spiral shape or may be shaped in the form of a cylindrical spring. The damping element is thus particularly easy to provide, and may be easily shaped along the circumferential direction in order to be inserted into the pocket.

According to a further advantageous embodiment, it is provided that the wire-shaped damping element includes a first contact section, a torsion section, and a second contact section, the at least one damping element along the circumferential direction being designed in such a way that the torsion section is situated between the first contact section and the second contact section, and the first and second contact sections of the damping element are configured to contact the guide blade element, and the torsion section is designed to exert an elastic force on the contact sections. In other words, the wire-shaped damping element has a periodic shape in the circumferential direction, in which the first contact section and the second contact section alternate along the damping element, and in each case the torsion section is inserted between the first contact section and the second contact section or between the second contact section and the first contact section. Due to the twisting of the torsion section, the torsion section acts as a torsion spring, and in the installed state presses the contact sections against the inner walls of the pocket of the guide blade element. The contact sections may have a semicircular or curved design, and the torsion section may extend along the circumferential direction. The damping element may have a C-shaped design in a section plane of an imaginary section perpendicular to the circumferential direction, and when the damping element is inserted into the pocket of the guide blade element the first contact section may be brought toward the second contact section in order to exert a force on the pocket. A radial movement of the guide blade elements relative to one another may thus generate friction, which imparts the damping property to the damping element. Installation across segments may couple multiple guide blade elements or guide blade ring segments to one another and against one another. It is possible to design the damping element as an overall ring that joins all guide blade elements of a guide blade ring together.

According to a further advantageous embodiment, it is provided that the damping element is designed as a C profile that is circularly or spirally wound around an imaginary axis that extends in parallel to the circumferential direction. In other words, the damping element may be designed as a metal sheet that is circularly or spirally wound, it being possible for the wound circular or spiral-shaped sheet metal spring to be curved along the circumferential direction in order to be or become inserted into the pocket of the guide blade element. With this embodiment, a particularly simple design of the damping element is possible which also has a sealing effect of the interior of the pocket with respect to the outside, since the damping element on the one hand contacts the hook section, and on the other hand contacts the shroud (the platform), at the inner side of the pocket. A particularly good friction effect of the damping element in the pocket of the guide blade element may be achieved with this embodiment.

According to a further advantageous embodiment, it is provided that an impulse body element is inserted into the pocket of the guide blade element. The impulse body element may include a receiving component designed as one piece and a closure component designed as one piece. The receiving component is designed for the provision of multiple separate cavities within the receiving component. Impulse bodies, for example spheres or a powder, are accommodatable in the cavities. The closure component is integrally joinable to the receiving component and may close the separate cavities which accommodate the impulse bodies. The impulse body may, for example, be made of a ceramic or may contain a ceramic. The impulse body element may include multiple receiving components that are arranged along the circumferential direction, and the spheres or the powder in the receiving component may be configured in such a way that predetermined frequencies may be absorbed particularly well by the impulse bodies and dissipated by friction. The impulse body element may be or become inserted into the pocket of the guide blade element, and neighboring guide blade elements may be connected to one another. The pocket of the guide blade element may thus exert a clamping effect on the impulse body element, so that the impulse body element may be held in the pocket of the guide blade element in a particularly advantageous manner. The impulse body element may, for example, be an impulse body module that is described in Utility Model DE 20 2021 103 804 U1.

According to a further advantageous embodiment, it is provided that at least one decambering slot, which in particular is in communicative connection with the pocket of the guide blade element, is inserted into the platform of each guide blade element. In other words, the platform or the shroud of each guide blade element may be interrupted by one or multiple decambering slots in order to prevent or reduce decambering of the guide blade element when heated. This means that when heated, the guide blade element may have a tendency to decamber or stretch, i.e., that a curvature of the guide blade element may decrease in the circumferential direction, which, however, is undesirable. A decambering slot may decrease or reduce the tendency to decamber. However, if the decambering slot extends to the pockets and is thus in communicative connection with the pockets, which are formed at the side of the guide blade element, a leakage path arises through which the gas or fluid flowing through the turbomachine can pass. However, this leakage flow may be reduced or sealed off by the guide blade element according to the present invention, which is designed as a C profile or as a corrugated metal sheet. This means that the damping element may decrease or close the leakage gap, and thus decrease or reduce the leakage flow.

According to a further advantageous embodiment, it is provided that the guide blade element is situated in a housing, the housing being designed to hold the damping element in the pocket of the guide blade element, and the housing being in direct contact with the damping element. In other words, in an installed state or in an operating state the guide blade element together with the damping element is situated in a housing. The housing holds the guide blade element via the hook sections and protrudes into the undercut of the guide blade element. The housing may be designed to hold the damping element in the pocket of the guide blade element and to contact the damping element. A particularly advantageous friction effect is thus achieved by the damping element, which is in direct contact with the housing.

According to a further aspect of the present disclosure, a thermal turbomachine through which axial flow may pass is provided with a blade arrangement according to the above description. As a result of the advantages described above, the thermal turbomachine through which axial flow may pass has a particularly low tendency to vibrate, and may thus be operated in a particularly advantageous manner.

### BRIEF DESCRIPTION OF THE DRAWINGS

Further features of the present invention result from the claims and the exemplary embodiments. The features and feature combinations mentioned above in the description as well as the features and feature combinations mentioned below in the exemplary embodiments and/or only shown alone may be used not only in the particular stated combination, but also in other combinations or alone without departing from the scope of the present invention. Thus, embodiments of the present invention not explicitly shown or explained in the exemplary embodiments, but which follow and are producible from the described embodiments via separate feature combinations, are regarded as encompassed and disclosed by the present invention. In addition, embodiments and feature combinations which thus do not include all features of an originally formulated independent claim are regarded as disclosed. In the figures:

FIG. 1 shows a partial area of a guide blade element of one exemplary embodiment in a schematic sectional illustration, in a view along a circumferential direction of the guide blade element;

FIG. 2A shows a schematic view of two guide blade elements according to a further exemplary embodiment, which are connected to one another via a damping element;

FIG. 2B shows a schematic view of a damping element according to a further exemplary embodiment for illustrating a geometric shape of the damping element;

FIG. 3A shows a partial area of a guide blade element according to a further exemplary embodiment in a schematic sectional illustration, in a view along a circumferential direction of the guide blade element;

FIG. 3B shows a schematic view of two guide blade elements according to a further exemplary embodiment, which are connected to one another via the damping element;

FIG. 4 shows a partial area of a guide blade element according to a further exemplary embodiment in a schematic sectional illustration, in a view along a circumferential direction of the guide blade element; and

FIG. 5 shows a schematic view of two guide blade elements according to a further exemplary embodiment, which are connected to one another via the damping element.

### DETAILED DESCRIPTION

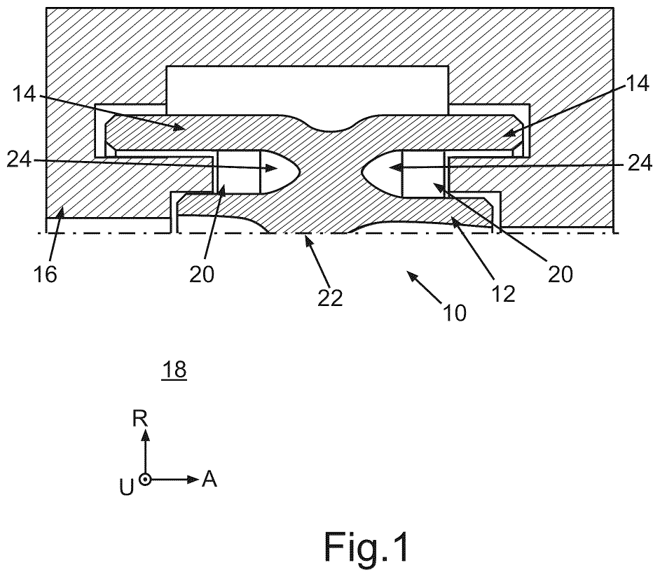

FIG. 1 shows a partial area of a guide blade element 10 of one exemplary embodiment, in a schematic sectional illustration of an imaginary section perpendicular to a circumferential direction U of guide blade element 10. Guide blade element 10 may be part of a turbomachine through which axial flow may pass, it being possible for the turbomachine to be a gas turbine or an aircraft gas turbine, for example. Guide blade element 10 includes a shroud or platform 12 and at least one hook section 14, which together with platform 12 forms a pocket 24 into which a damping element 20 is inserted in the installed state shown here. In addition, guide blade element 10 includes an airfoil 22 that protrudes or projects radially inwardly from platform 12. Hook section 14 is situated at a radial outer side of platform 12. In the radial direction, hook section 14 forms pocket 24 into which damping element 20 is inserted. Pocket 24 is delimited by the at least one hook section 14, guide blade element 10, and platform 12. In the axial direction, pocket 24 is open at one side. Two pockets 24 are preferably provided which are open with respect to the downstream direction and with respect to the upstream direction. The at least one damping element 20, which is situated in pocket 24 of each guide blade element 10 of the at least two guide blade elements 10, connects at least two neighboring guide blade elements 10 to one another. In other words, guide blade elements 10 that neighbor one another in circumferential direction U are connected or coupled to one another by a respective damping element 20. A friction effect is achieved on damping element 20 due to an axial or radial movement of the guide blade elements 10 against one another, so that oscillation energy may be converted into frictional heat, and a vibration amplitude of a natural oscillation of guide blade element 10 may be reduced. It is thus possible to operate guide blade elements 10, and thus the turbomachine, in a particularly low-vibration manner. Airfoil 22 protrudes into a flow area 18 of the turbomachine. Pocket 24 of each guide blade element 10 forms an undercut of guide blade element 10 in the radial direction.

Guide blade element 10 may be produced using an additive manufacturing process, for example. An additive or generative manufacturing process is known in which, for example, a component may be built up in layers. This may be carried out using a laser process, an electron beam melting process, or an electron beam sintering process. For example, a powder may be locally solidified in layers by melting, sintering, or fusing the powder using a high-energy beam such as a laser beam or electron beam. In particular components with a high degree of geometric complexity, such as guide blade element 10 disclosed above, may be easily manufactured using additive or generative manufacturing processes.

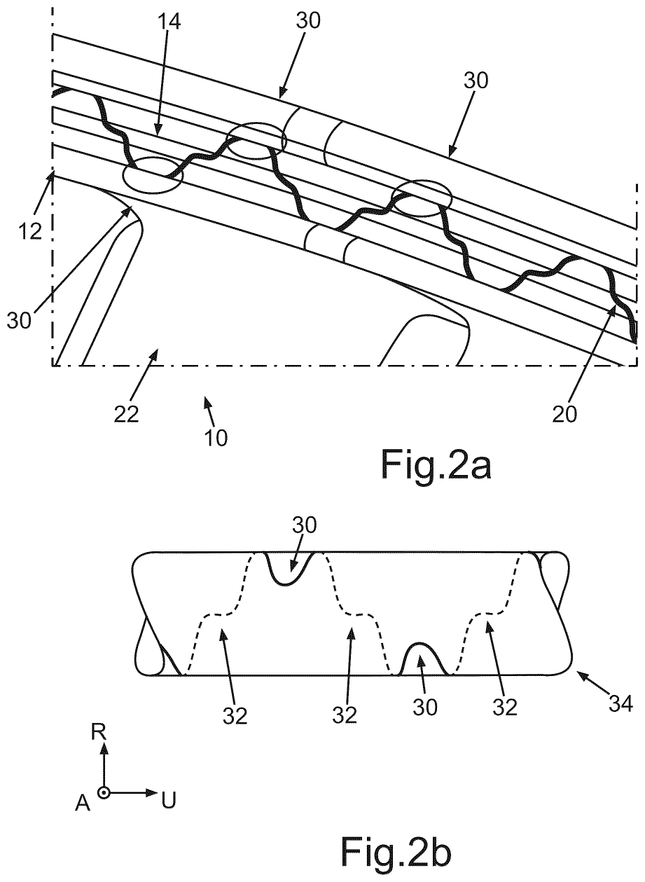

FIG. 2A shows a schematic view of two guide blade elements 10 according to a further exemplary embodiment, which are connected to one another by a damping element 20. Damping element 20 may be designed as a corrugated metal sheet, for example as shown in FIG. 1, or may have a wire-shaped design with a periodic shape in circumferential direction U. For example, damping element 20 may have a spring-like, spiral, and/or clamp-like shape. Particularly advantageous simple manufacture may be achieved via the periodic shape in circumferential direction U.

FIG. 2B shows a schematic view of a damping element 20 according to a further exemplary embodiment for illustrating a geometric shape of damping element 20. Damping element 20 may include a first contact section 30, a torsion section 32, and a second contact section 30, damping element 20 being designed along circumferential direction U in such a way that a torsion section 32 is situated in each case between first contact section 30 and second contact section 30. First and second contact sections 30 of damping element 20 may each be configured to contact or touch in an installed state of guide blade element 10, and torsion section 32 may be designed to exert an elastic force on contact sections 30 by torsion section 32 being twisted about an imaginary axis along circumferential direction U. Each contact section 30 may have a semicircular or curved design. Torsion section 32 may extend along circumferential direction U. The wire-shaped damping element may have a C-shaped design in a section plane of an imaginary section perpendicular to circumferential direction U, and may extend along a cylindrical surface of an imaginary cylinder 34.

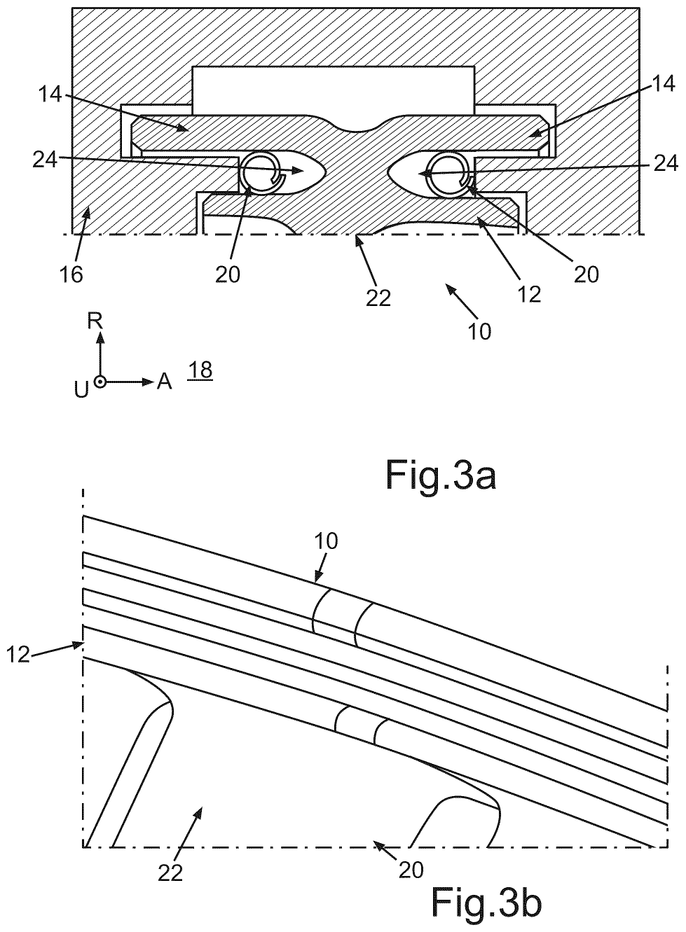

FIG. 3A shows a partial area of a guide blade element 10 according to a further exemplary embodiment, in a schematic sectional illustration in a view along a circumferential direction U of guide blade element 10. According to this exemplary embodiment, damping element 20 is designed as a C profile, and has a shape in which the C profile is circularly or spirally wound around an imaginary axis that extends in parallel to circumferential direction U. The C profile thus forms a sheet metal spring which has a spiral or circular shape in the plane of FIG. 3A. The sheet metal spring thus exerts a force on the points of contact between damping element 20 and guide blade element 10, so that a friction effect is achieved.

FIG. 3B shows a schematic view of two guide blade elements 10 according to a further exemplary embodiment, which are connected to one another by damping element 20. As stated above, damping element 20 may be designed as a C profile and may be inserted into pocket 24 of guide blade element 10 or of guide blade elements 10. In this case, a sealing effect of pocket 24 with respect to an outer flow area 18 is also achieved by damping element 20. If a housing 16 is situated around guide blade element 10 according to FIG. 3A, a sealing effect may also be achieved by contact with housing 16.

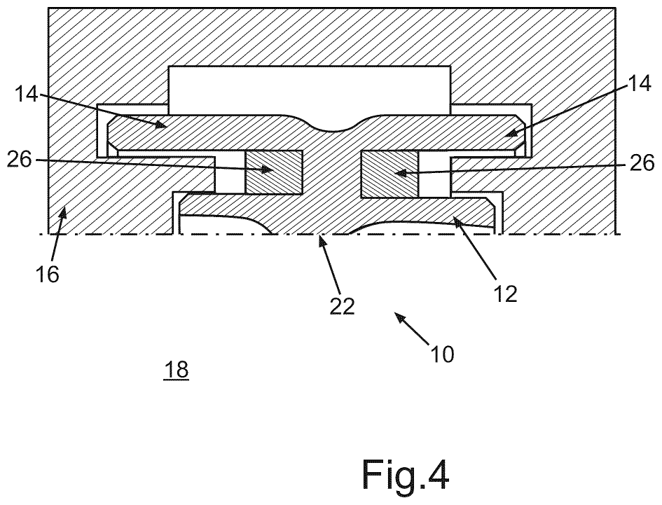

FIG. 4 shows a partial area of a guide blade element 10 according to a further exemplary embodiment, in a schematic sectional illustration in a view along circumferential direction U of guide blade element 10. In this exemplary embodiment an impulse body element 26 is inserted into pocket 24 of guide blade element 10. Impulse body element 26 may include a receiving component that is formed as one piece, and a closure component that is formed as one piece. The receiving component may be designed for the provision of multiple separate cavities within the receiving component. Impulse bodies may thus be accommodated in the cavities. The impulse bodies may be spheres, or a powder. The closure component may be integrally joined to the receiving component. In addition, a plurality of cavities in which an impulse body is accommodatable in each case may be formed in the receiving component. The closure component may also be referred to as a cover. In other words, the impulse body element may, for example, include spheres in their own respective compartments. The impulse body element may be designed to at least minimize a possible oscillation mode or possible oscillation modes in an operating state of the turbomachine. A particularly preferred minimization of oscillation may thus be achieved.

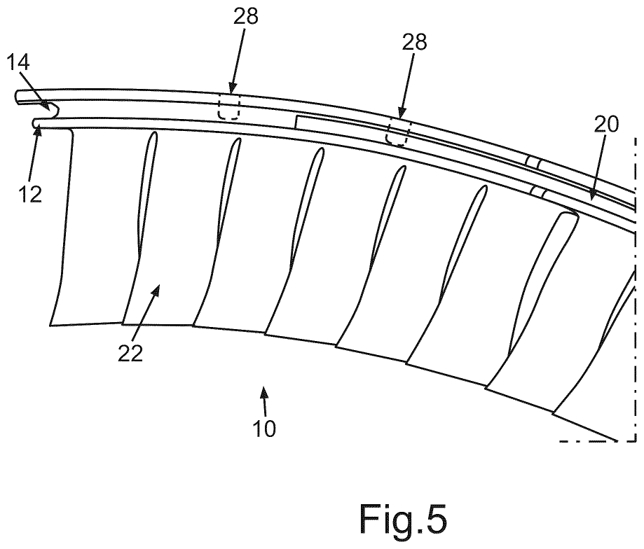

FIG. 5 shows a schematic view of two guide blade elements 10 according to a further exemplary embodiment, which are connected to one another by damping element 20. At least one decambering slot 28 which may be in communicative connection with pocket 24 of guide blade element 10 may be inserted into platform 12 of each guide blade element 10. By use of decambering slot 28, a tendency of guide blade element 10 to decamber when heated may be reduced, and decambering or stretching of guide blade element 10, which is undesirable, may be reduced. A leakage path arises if decambering slot 28 extends to pockets 24 or to pocket 24. This leakage path may be sealed off by damping element 20, it being possible for damping element 20 to be designed, for example, as a C profile or as an impulse body element 26 according to the above description. Damping element 20 closes the gap and decreases a leakage path between decambering slot 28 and a flow area 18 of the turbomachine. If guide blade element 10 is situated in a housing 16, housing 16 may be designed to hold damping element 20 in pocket 24 of guide blade element 10, and housing 16 may be in direct contact with damping element 20. Damping element 20 may thus be held by housing 16, and a particularly advantageous damping effect may be achieved due to friction at guide blade element 10 or housing 16.

### LIST OF REFERENCE SYMBOLS

10 guide blade element
12 platform
14 hook section
16 housing
18 flow area
20 damping element
22 airfoil
24 pocket
26 impulse body element
28 decambering slot
30 contact section
32 torsion section
A axial direction
R radial direction
U circumferential direction

What is claimed is:

1. A blade arrangement for a thermal turbomachine through which axial flow may pass, The blade arrangement comprising:
a guide blade ring having:
at least two guide blade elements situated along a circumferential direction of the turbomachine;
each guide blade element of the at least two guide blade elements including at least one airfoil and a platform at a radially outer end of the airfoil and connected in one piece to the at least one airfoil;
at least one hook section at a radially outer side protruding from the platform in the radial direction,
the at least one hook section in the radial direction forming a pocket of the guide blade element, the pocket delimited by the at least one hook section, the guide blade element, and the platform, and being open at one side in an axial direction of the turbomachine, and
at least one damping element situated in the pocket.

2. The blade arrangement as recited in claim 1 wherein the pocket of each guide blade element of the at least two guide blade elements forms an undercut of the guide blade element in a radial direction.

3. The blade arrangement as recited in claim 1 wherein each guide blade element of the at least two guide blade elements is produced using an additive manufacturing process.

4. The blade arrangement as recited in claim 1 wherein the at least one damping element is designed as a corrugated metal sheet having an undulating structure in the circumferential direction.

5. The blade arrangement as recited in claim 1 wherein the at least one damping element connects at least two neighboring guide blade elements in the circumferential direction.

6. The blade arrangement as recited in claim 5 wherein the at least one damping element includes a first contact section, a torsion section, and a second contact section, the at least one damping element along the circumferential direction being designed in such a way that the torsion section is situated between the first contact section and the second contact section, the first and second contact sections of the damping element being configured to contact the guide blade element, and the torsion section being designed to exert an elastic force on the contact sections.

7. The blade arrangement as recited in claim 1 wherein the damping element is designed as a C profile circularly or spirally wound around an imaginary axis extending in parallel to the circumferential direction.

8. A blade arrangement for a thermal turbomachine through which axial flow may pass, The blade arrangement comprising:
a guide blade ring having:
at least two guide blade elements situated along a circumferential direction of the turbomachine;
each guide blade element of the at least two guide blade elements including at least one airfoil and a platform at a radially outer end of the airfoil and connected in one piece to the at least one airfoil;
at least one hook section at a radially outer side protruding from the platform in the radial direction,
the at least one hook section in the radial direction forming a pocket of the guide blade element, the pocket delimited by the at least one hook section, the guide blade element, and the platform, and being open at one side in an axial direction of the turbomachine, and
an impulse body element is inserted into the pocket of the guide blade element.

9. The blade arrangement as recited in claim 1 wherein at least one decambering slot is inserted into the platform of each guide blade element.

10. The blade arrangement as recited in claim 9 wherein the least one decambering slot is in communicative connection with the pocket.

11. The blade arrangement as recited in claim 1 wherein the guide blade element (10) is situated in a housing, the housing being designed to hold the damping element in the pocket of the guide blade element, and the housing being in direct contact with the damping element (20).

12. The thermal turbomachine through which axial flow may pass comprising the blade arrangement as recited in claim 1.
